(19) United States
(12) Patent Application Publication
(10) Pub. No.: US 2012/0140881 A1
(43) Pub. Date: Jun. 7, 2012

(54) RADIATION DETECTOR AND RADIOGRAPHIC APPARATUS

(76) Inventors: Akina Yoshimatsu, Osaka (JP); Koichi Tanabe, Uji-shi (JP); Satoshi Tokuda, Kusatsu-shi (JP); Toshinori Yoshimuta, Osaka (JP); Hiroyuki Kishihara, Kizugawa-shi (JP); Masatomo Kaino, Soraku-gun (JP); Toshiyuki Sato, Kyoto-shi (JP); Shoji Kuwabara, Osaka (JP)

(21) Appl. No.: 13/270,258

(22) Filed: Oct. 11, 2011

(30) Foreign Application Priority Data
Dec. 2, 2010 (JP) JP2010-269430

(51) Int. Cl. G01T 1/24; G01N 23/04

(52) U.S. Cl. 378/62; 250/370.01; 250/370.12; 250/370.13

(57) ABSTRACT

A drive controller varies a bias voltage applied from a bias supply to a conversion layer based on the presence or absence of binning, that is, for a case of carrying out binning where switching elements are driven on the basis of a plurality of rows at a time by a gate drive circuit, and for a case of carrying out no binning where the switching elements are driven on a row-by-row basis by the gate drive circuit. Therefore, in the case of a fluoroscopic mode for acquiring images with binning, a lowering of a dynamic range can be suppressed. In the case of a radiographic mode with no binning, spatial resolution can be made high. That is, a high dynamic range and high spatial resolution can be optimized according to modes of operation.

### BACKGROUND OF THE INVENTION

(1) Field of the Invention

This invention relates to a radiation detector and a radiographic apparatus used in the medical field or industrial field for detecting radiation such as X-rays or gamma rays.

(2) Description of the Related Art

Conventionally, a flat panel X-ray detector (hereinafter abbreviated as “FPD” as appropriate), for example, is known as this type of radiation detector. The FPD has a construction including, laminated one over the other, a conversion layer which converts X-rays into electric charges (signal charges), and an active matrix substrate for storing and reading the charges converted by the conversion layer.

As shown in FIG. 1, an active matrix substrate 111 has a two-dimensional arrangement of storage capacitors 113 for storing electric charges converted by a conversion layer 103, and switching elements 115 for reading the electric charges stored in the storage capacitors 113. Gate (address) lines G1-G10 and data (read) lines D1-D10 are connected to input and output terminals of the switching elements 115, respectively. The switching elements 115 are placed in a connected (ON) state by signals given from the gate lines G1-G10. Consequently, the electric charges stored in the storage capacitors 113 are read from the data lines D1-D10 through the switching elements 115. In this example, a bias voltage Va is applied to the conversion layer 103 from a bias supply 109 (see Japanese Unexamined Patent Publication No. 2000-349269, for example).

The FPD 101 with such construction has, as modes of operation, a “radiographic mode” for acquiring still images and a “fluoroscopic mode” for acquiring dynamic images. That is, where the FPD 101 is used for both radiography and fluoroscopy, images are acquired in the radiographic mode or fluoroscopic mode by changing the modes of operation. In the radiographic mode, the switching elements 115 arranged in two dimensions are operated on a row-by-row basis. That is, in the radiographic mode, in which spatial resolution is an important consideration, a reading operation is carried out on a pixel-by-pixel basis (i.e. for each detecting element DU). In the fluoroscopic mode, on the other hand, the pixels are binned in order to secure a charge amount and a large frame rate.

Binning refers to handling of a plurality of adjoining pixels as one pixel. As shown in FIG. 1, 2×2 pixels a-d may be combined into one pixel, for example. In a specific operation, signals are transmitted at the same time from a gate drive circuit 119 to two gate lines G1 and G2, to drive the switching elements 115 of the pixels a-d and other pixels connected to these gate lines G1 and G2. Then, the electric charges for two pixels stored in the pixel a and pixel b are read from the data line D1, and the electric charges for two pixels stored in the pixel c and pixel d are read from the data line D2. The electric charges for the two pixels, respectively, are converted into voltage signals by charge-to-voltage converting amplifiers 121, which pass through a multiplexer 123, and are converted from analog values into digital values by an analog-to-digital converter 125. Then, an image processor 131 or the like adds up the voltage signals (X-ray detection signals) for the two pixels adjoining horizontally, respectively (pixel a+pixel b, and pixel c+pixel d), to obtain a voltage signal for one pixel combining the four pixels (pixel a+pixel b+pixel c+pixel d).

For imaging in the radiographic mode or fluoroscopic mode, that is regardless of whether binning is done or not, a constant bias voltage Va is usually applied to the conversion layer 103 for use.

In the case of the fluoroscopic mode in which 2×2 pixels, for example, are binned as described above, electric charges for two pixels are read from the data lines D1-D10. However, the storage capacitors 113 receive and store, besides the electric charges converted from X-rays incident on the conversion layer 103, electric charges due to leak currents flowing even when X-rays are not incident on the conversion layer 103. Thus, the electric charges due to the leak currents for two pixels will also be read. Consequently, the electric charges due to the leak currents for two pixels will be stored in amplifiers storage capacitors 129 of the charge-to-voltage converting amplifiers 121 located downstream, thereby reducing available effective capacities thereof. This poses a problem of lowering a dynamic range DR. In particular, a detector that uses a compound semiconductor which is a high sensitivity material, such as CdTe or CdZnTe, for the conversion layer 103, since resistivity is small compared with the conversion layer 103 formed of a-Se or the like, has a property of being susceptible to leak current flows when the bias voltage Va is applied. This results in a serious influence of the lowering of the dynamic range DR.

### SUMMARY OF THE INVENTION

This invention has been made having regard to the state of the art noted above, and its object is to provide a radiation detector and a radiographic apparatus which can suppress lowering of a dynamic range when images are acquired with binning.

The above object is fulfilled, according to this invention, by a radiation detector for detecting radiation, comprising a conversion layer for converting incident radiation into electric charges; a bias supply for applying a bias voltage to the conversion layer; storage capacitors arranged in two dimensions for storing the electric charges converted by the conversion layer; switching elements arranged in two dimensions for reading the electric charges stored in the storage capacitors; a gate drive circuit for selectively driving the switching elements on one of a basis of one row at a time and a basis of a plurality of rows at a time; and a controller for varying the bias voltage applied from the bias supply to the conversion layer according to a case of carrying out binning in which the gate drive circuit drives the switching elements on the basis of the plurality of rows at a time, and a case without the binning in which the gate drive circuit drives the switching elements on the oasis of one row at a time.

According to the radiation detector of this invention, the controller varies the bias voltage applied from the bias supply to the conversion layer based on the presence or absence of binning, that is, for the case of carrying out binning where the switching elements are driven on a basis of a plurality of rows at a time by the gate drive circuit, and for the case of carrying out no binning where the switching elements are driven on a row-by-row basis by the gate drive circuit. Therefore, in the case of a fluoroscopic mode for acquiring images with binning, a lowering of the dynamic range can be suppressed. In the case of a radiographic mode with no binning, the spatial resolution can be made high. That is, with a conventional apparatus, the dynamic range will be reduced when the bias voltage required for the radiographic mode is used as it is for the fluoroscopic mode, and spatial resolution will be reduced when the bias voltage is set low to suit the fluoroscopic mode. However, this invention can secure both high dynamic range and high spatial resolution according to the modes of operation.

In the above radiation detector, it is preferred that the controller is arranged to set the bias voltage applied from the bias supply to the conversion layer lower for the case of carrying out the binning than for the case without the binning. Consequently, the bias voltage is set lower for the fluoroscopic mode which acquires images by binning 2×2 pixels, for example, than when no binning is carried out, thereby reducing the amount of read-out charges due to leak current for two pixels, to suppress lowering of the dynamic range. The bias voltage is set higher for the radiographic mode which acquires images with no binning, than when binning is carried out, thereby increasing the spatial resolution.

In the above radiation detector, it is preferred that the larger is the number of rows of the switching elements driven by the gate drive circuit, the lower the controller is arranged to set the bias voltage applied from the bias supply to the conversion layer. In this way, a lowering of the dynamic range can be suppressed according to the number of pixels in the vertical direction to be binned (the number of rows).

In a preferred example of the above radiation detector, the conversion layer is formed of one of CdTe and CdZnTe. CdTe or CdZnTe is highly sensitive to incident X-rays, and has a large amount of leak current compared with a-Se, for example. Therefore, when binning 2×2 pixels, the dynamic range will lower since the charges due to leak current for two pixels are read. However, by changing the bias voltage, the lowering of the dynamic range can be suppressed.

In another aspect of the invention, a radiographic apparatus for acquiring still images and dynamic images, comprises a radiation emitter for emitting radiation; and a radiation detector for detecting radiation transmitted through a subject; wherein the radiation detector includes a conversion layer for converting incident radiation into electric charges; a bias supply for applying a bias voltage to the conversion layer; storage capacitors arranged in two dimensions for storing the electric charges converted by the conversion layer; switching elements arranged in two dimensions for reading the electric charges stored in the storage capacitors; a gate drive circuit for selectively driving the switching elements on one of a basis of one row at a time and a basis of a plurality of rows at a time; and a controller for varying the bias voltage applied from the bias supply to the conversion layer according to a case of carrying out binning in which the gate drive circuit drives the switching elements on the basis of the plurality of rows at a time, and a case without the binning in which the gate drive circuit drives the switching elements on the basis of one row at a time.

According to the radiographic apparatus of this invention, the controller varies the bias voltage applied from the bias supply to the conversion layer based on the presence or absence of binning, that is, for the case of carrying out binning where the switching elements are driven on the basis of a plurality of rows at a time by the gate drive circuit, and for the case of carrying out no binning where the switching elements are driven on the row-by-row basis by the gate drive circuit. Therefore, in the case of a fluoroscopic mode for acquiring images with binning, a lowering of the dynamic range can be suppressed. In the case of a radiographic mode with no binning, the spatial resolution can be made high. That is, with a conventional apparatus, the dynamic range will be reduced when the bias voltage required for the radiographic mode is used as it is for the fluoroscopic mode, and spatial resolution will be reduced when the bias voltage is set low to suit the fluoroscopic mode. However, this invention can secure both high dynamic range and high spatial resolution according to the modes of operation.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a plan view showing an outline construction of a conventional flat panel X-ray detector;

FIG. 2 is a view in vertical section showing an outline construction of a flat panel X-ray detector according to Embodiment 1;

FIG. 3 is a plan view showing the outline construction of the flat panel X-ray detector according to Embodiment 1;

FIG. 4A is a view conceptually showing a relationship between bias voltage (electric field) and dynamic range DR in a case of no binning (1×1 pixel);

FIG. 4B is a view conceptually showing a relationship between bias voltage (electric field) and spatial resolution MTF in the case of no binning (1×1 pixel);

FIG. 5A is a view conceptually showing a relationship between bias voltage (electric field) and dynamic range DR in a case of binning (2×2 pixels);

FIG. 5B is a view conceptually showing a relationship between bias voltage (electric field) and spatial resolution MTF in the case of binning (2×2 pixels);

FIG. 6 is a view showing an outline construction of an X-ray apparatus according to Embodiment 2;

FIG. 7A is a view conceptually showing a relationship between bias voltage (electric field) and dynamic range DR based on the number of vertical pixels to be binned according to a modification;

FIG. 7B is a view conceptually showing a relationship between bias voltage (electric field) and spatial resolution MTF based on the number of vertical pixels to be binned according to the modification; and

FIG. 7C is a view conceptually showing a relationship between the number of vertical pixels to be binned and bias voltage (electric field) according to the modification.

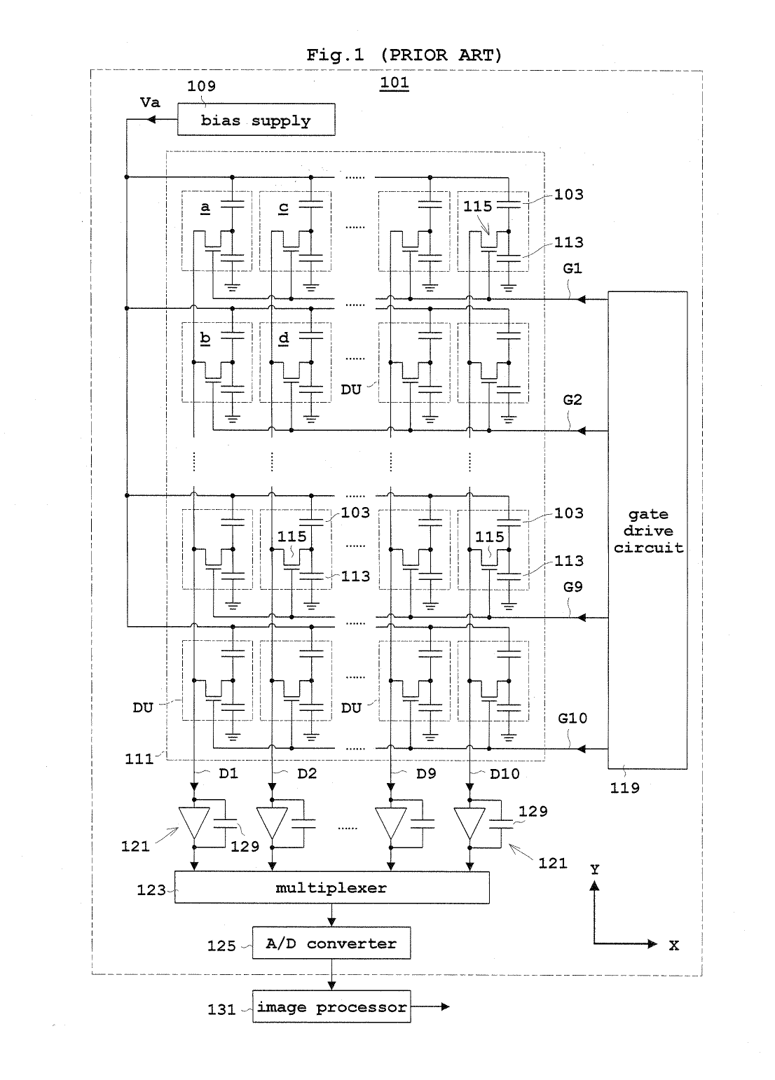

### DESCRIPTION OF THE PREFERRED EMBODIMENTS

Preferred embodiments of this invention will be described in detail hereinafter with reference to the drawings.

### Embodiment 1

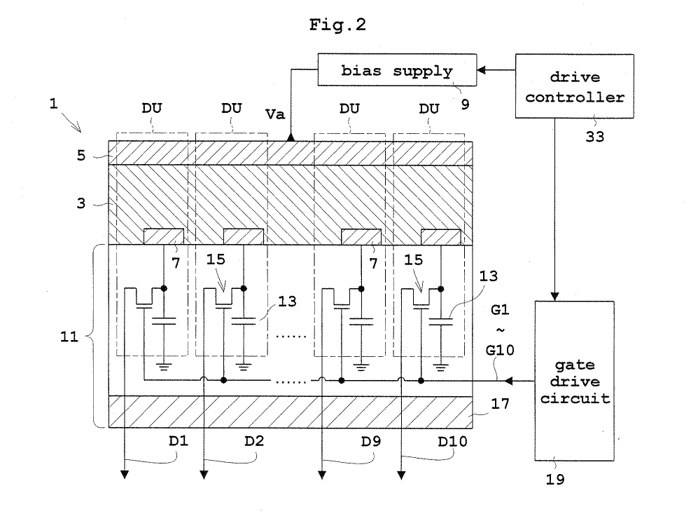

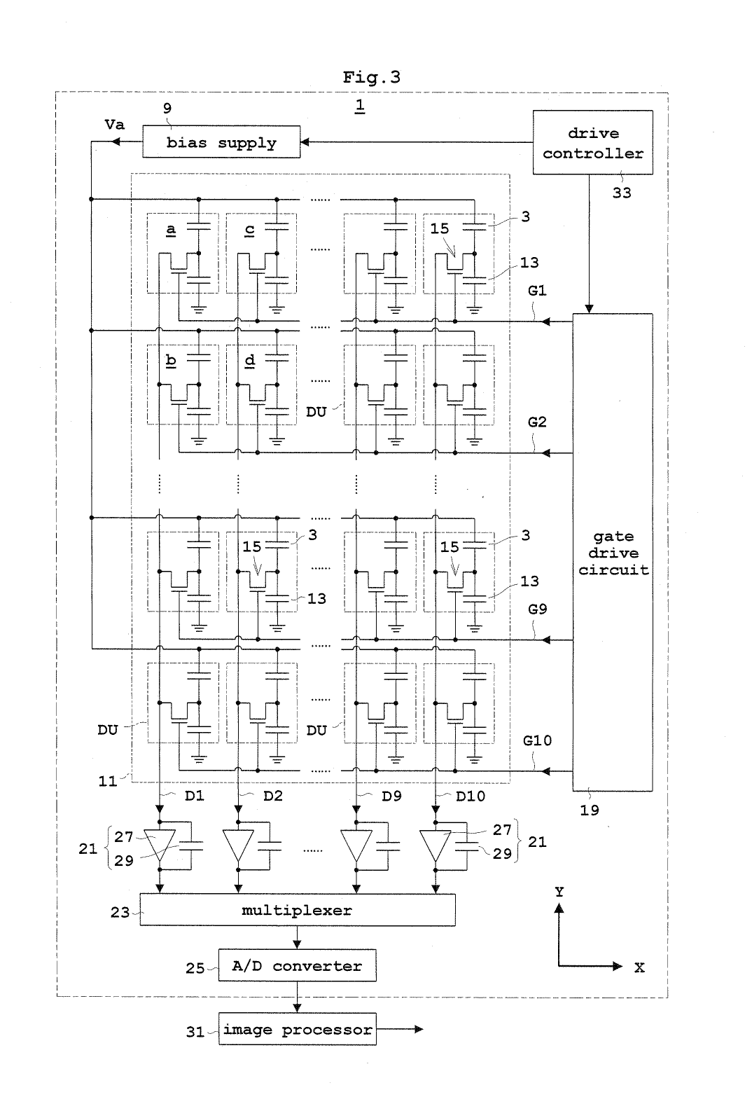

In the following embodiments, a flat panel X-ray detector will be described as an example of the radiation detector. FIG. 2 is a view in vertical section showing an outline construction of a flat panel X-ray detector according to Embodiment 1. FIG. 3 is a plan view thereof.

Reference is made to FIGS. 2 and 3. A flat panel X-ray detector (FPD) 1 includes a conversion layer 3 for converting incident X-rays directly into electric charges, a common electrode 5 disposed on one surface of the conversion layer 3 for application of a bias voltage Va, and pixel electrodes 7 arranged opposite the common electrode 5 across the conversion layer 3 for collecting the electric charges converted by the conversion layer 3.

The conversion layer 3 is formed of a-Se (amorphous selenium), CdTe (cadmium telluride) or CdZnTe (cadmium telluride zinc), for example. When the conversion layer 3 is formed of a-Se, a bias voltage Va of about 10 kV is applied. When the conversion layer 3 is formed of CdTe or CdZnTe, a bias voltage Va of about 100V is applied. The bias voltage Va is applied to the common electrode 5. That is, the bias voltage Va is applied to the conversion layer 3 through the common electrode 5. The bias voltage Va is applied from a bias supply 9. The bias supply 9 can change set voltage values as necessary.

The common electrode 5 is common to all pixels, and the plurality of pixel electrodes 7 are arranged in two dimensions (in matrix form) to correspond to the respective pixels.

The FPD 1 further includes an active matrix substrate 11 disposed on the side of the conversion layer 3 adjacent the pixel electrodes 7 for storing and reading the charges converted by the conversion layer 3. The active matrix substrate 11 has storage capacitors 13 and switching elements 15 corresponding to the respective pixels. The storage capacitors 13 store the charges converted by the conversion layer 3. The switching elements 15 are formed of thin-film transistors (TFTs) or the like for making and breaking electrical connection between the storage capacitors 13 and data lines D1-D10, to be described hereinafter, in order to read the charges stored in the storage capacitors 13. For expediency of description, it is assumed that the storage capacitors 13 and switching elements 15 are in a 10×10 arrangement (10×10 pixels) in this embodiment.

The active matrix substrate 11 has gate lines G1-G10 and data lines D1-D10. The gate lines G1-G10 are provided for respective rows in the horizontal direction of the switching elements 15 arranged in two dimensions, and are connected to the gates of the switching elements 15 in the respective rows. The data lines D1-D10 are provided for respective columns in the vertical direction of the switching elements 15 arranged in two dimensions, and are connected to the sides (readout sides) opposite the storage capacitors 13 of the switching elements 15 in the respective columns.

The active matrix substrate 11 has the storage capacitors 13, switching elements 15, gate lines G1-G10 and data lines D1-D10 arranged on an insulating substrate 17. Detecting elements DU are formed of the conversion layer 3, common electrodes 5, pixel electrodes 7, storage capacitors 13 and switching elements 15. The detecting elements DU are arranged in two dimensions. Each detecting element DU corresponds to one pixel of an X-ray image.

The FPD 1 further includes a gate drive circuit 19 for driving the switching elements 15 in one row or a plurality of rows at a time, through the gate lines G1-G10. The gate drive circuit 19 is electrically connected to the plurality of gate lines G1-G10. By applying voltage and transmitting a signal from the gate drive circuit 19 to each of the gate lines G1-G10, the switching elements 15 are placed in a connected (ON) state to read the charges from the storage capacitors 13. When, for example, an image is acquired through a 2×2 pixel binning process, the switching elements 15 in two rows are driven at a time by applying voltage to two gate lines at the same time.

Further, the FPD 1 includes charge-to-voltage converting amplifiers 21, a multiplexer 23 and an analog-to-digital converter 25. The charge-to-voltage converting amplifiers 21 convert the charges fetched through the data lines D1-D10 into voltages for output as voltage signals. Each charge-to-voltage converting amplifier 21 has an amplifier 27 connected to one of the data lines D1-D10, and an amplifier's storage capacitor 29 connected in parallel to input and output ends of this amplifier 27. The multiplexer 23 outputs one voltage signal selected from a plurality of voltage signals. The analog-to-digital converter 25 converts the voltage signal from an analog value into a digital value. An image processor 31 is provided downstream of the analog-to-digital converter 25 for carrying out various processes, such as offset correction, on an X-ray image based on the voltage signals (X-ray detection signals).

The bias supply 9 and gate drive circuit 19 are controlled by a drive controller 33. The drive controller 33 switches operating modes, between a radiographic mode for acquiring still images and a fluoroscopic mode for acquiring dynamic images. Specifically, in the radiographic mode, a bias voltage Va for the radiographic mode is applied to the conversion layer 3. In the fluoroscopic mode, a bias voltage Va for the fluoroscopic mode set lower than the bias voltage Va for the radiographic mode is applied to the conversion layer 3. In the radiographic mode, the switching elements 15 arranged in two dimensions are driven on a row-by-row basis. In the fluoroscopic mode in which binning is carried out, a plurality of rows of the switching elements 15 arranged in two dimensions are driven at a time. The drive controller 33 corresponds to the controller in this invention.

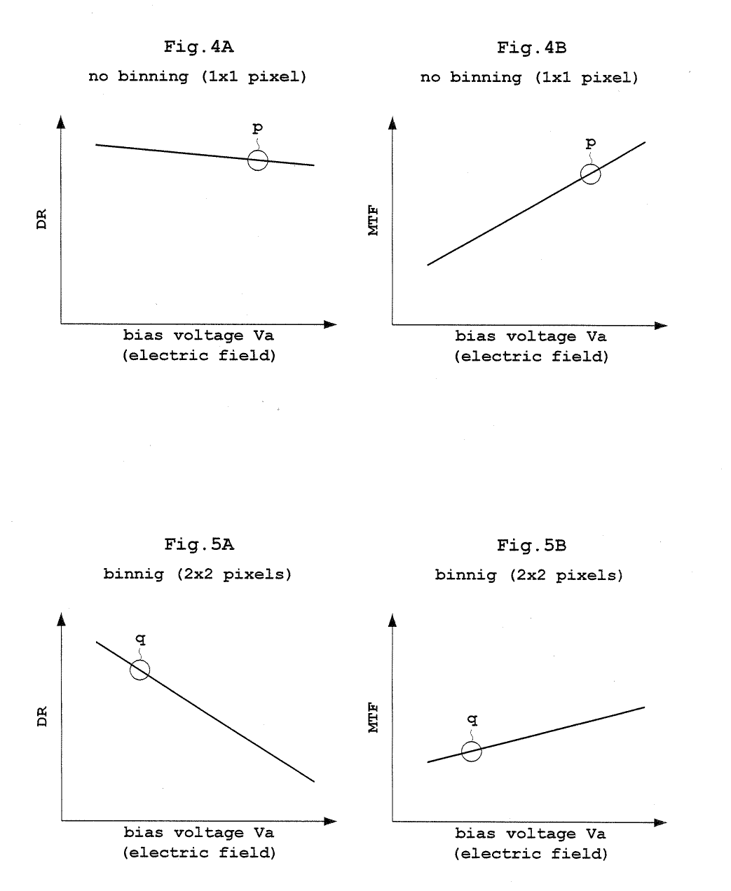

The drive controller 33 changes the bias voltage Va applied from the bias supply 9 to the conversion layer 3 in order to acquire images in the radiographic mode or fluoroscopic mode, that is based on the presence or absence of binning. Reference is made to FIGS. 4A, 4B, 5A and 5B. FIG. 4A is a view conceptually showing a relationship between bias voltage (electric field) and dynamic range DR in a case of no binning (1×1 pixel). FIG. 4B is a view conceptually showing a relationship between bias voltage (electric field) and spatial resolution MTF in the case of no binning (1×1 pixel). FIG. 5A is a view conceptually showing a relationship between bias voltage (electric field) and dynamic range DR in a case of binning (2×2 pixels). FIG. 5B is a view conceptually showing a relationship between bias voltage (electric field) and spatial resolution MTF in the case of binning (2×2 pixels).

In the radiographic mode with no binning, as shown in FIG. 4A, the lowering of dynamic range DR is relatively small even if the bias voltage Va is set high. As shown in FIG. 4B, the higher the bias voltage Va is set, the higher becomes the spatial resolution MTF. Therefore, by setting a relatively high bias voltage Va for use, an image with excellent spatial resolution MTF as indicated by sign p can be acquired.

On the other hand, in the fluoroscopic mode with binning, as shown in FIG. 5A, the higher the bias voltage Va is set, the larger becomes the lowering of dynamic range DR. Although the spatial resolution MTF becomes higher with the bias voltage Va set higher as shown in FIG. 5B, its variation (gradient) is relatively small since, in the first place, the space resolution MTF is lowered by the binning. Since the lowering of dynamic range DR is large when the bias voltage Va is set high, it is necessary to lower the bias voltage Va as much as possible. The lowering of space resolution MTF due to the bias voltage set low is relatively small. Therefore, an image with large dynamic range DR can be acquired by setting a lower bias voltage Va for use than in the case of no binning, as indicated by sign q, for example.

In this way, the bias voltage Va applied to the conversion layer 3 is made a variable bias by the bias supply 9. The bias voltage Va for the radiographic mode with no binning, and the bias voltage Va for the fluoroscopic mode with binning, which is set lower than for the case with no binning, are selectively used according to the respective modes of operation.

Next, operation of the FPD 1 in this embodiment will be described. Based on a setting for selecting the radiographic mode for acquiring a still image or the fluoroscopic mode for acquiring a dynamic image, the drive controller 33 operates the bias supply 9 and gate drive circuit 19. The setting for selecting the radiographic mode or the fluoroscopic mode is made, for example, through an input unit not shown. First, it is assumed that the setting is made for the fluoroscopic mode for binning 2×2 pixels.

[Fluoroscopic mode] A predetermined bias voltage Va for the fluoroscopic mode is applied from the bias supply 9 to the conversion layer 3. The bias voltage Va for the fluoroscopic mode is set lower than that for the radiographic mode. In the state of the bias voltage Va for the fluoroscopic mode being applied, X-rays are emitted from an X-ray tube not shown. The emitted X-rays pass through a subject and fall on the conversion layer 3 of FPD 1. Reference is made to FIG. 2. The incident X-rays are converted into electric charges in the conversion layer 3 according to X-ray intensity of an X-ray image formed by transmission through the subject. The converted electric charges are collected by the pixel electrodes 7 arranged in two dimensions, and stored in the storage capacitors 13 provided for the respective pixel electrodes 7.

The electric charges stored in the storage capacitors 13 are read therefrom. The gate drive circuit 19 carries out a read operation in the fluoroscopic mode for binning 2×2 pixels. Reference is made to FIG. 3. The gate drive circuit 19 drives the switching elements 15 in a plurality of rows at a time. That is, when binning 2×2 pixels, the gate drive circuit 19 drives the switching elements 15 by successively applying voltage and sending signals to every two of the gate lines D1-D10 connected to the respective rows in the horizontal direction of the switching elements 15.

Consequently, the switching elements 15 in the rows connected to the gate lines G1 and G2, for example, are driven, and the charges stored in their respective storage capacitors 13 are read through the data lines D1-D10. At this time, the charges for two pixels, i.e. pixel a and pixel b (pixel a+pixel b), are read through the data line D1, while the charges for two pixels, i.e. pixel c and pixel d (pixel c+pixel d), are read through the data line D2.

The charges read through the data lines D1-D10 are inputted to the charge-to-voltage converting amplifiers 21, stored in the amplifier's storage capacitors 29, and outputted as amplified voltage signals. Since the bias voltage Va for the fluoroscopic mode is applied to the conversion layer 3, the charges for two pixels, with reduced charges due to leak currents, are stored in the amplifier's storage capacitors 29.

The multiplexer 23 selects and outputs one of the voltage signals read through the data lines D1-D10 and converted by the charge-to-voltage converting amplifiers 21. The voltage signal outputted from the multiplexer 23 is converted from the analog value into a digital value by the analog-to-digital converter 25, and is outputted therefrom. The voltage signal converted into the digital value by the analog-to-digital converter 25 is outputted from the FPD 1, and is fed as an X-ray detection signal into the image processor 31 at a subsequent stage.

When binning 2×2 pixels, the image processor 31 adds every two pixels adjoining in the horizontal direction. That is, pixel a+pixel b read from the data line D1 and pixel c+pixel d read from the data line D2 are added to obtain “pixel a+pixel b+pixel c+pixel d”. The image processor 31 carries out other processes required, such as offset correction. In this way, an X-ray image (dynamic image) with 2×2 pixels binned into one pixel is acquired. The X-ray image processed by the image processor 31 is displayed on a monitor not shown, or stored in a memory unit not shown.

[Radiographic mode] A predetermined bias voltage Va for the radiographic mode is applied from the bias supply 9 to the conversion layer 3. In the state of the bias voltage Va for the radiographic mode being applied, X-rays fall on the conversion layer 3 of FPD 1. The incident X-rays are converted into electric charges in the conversion layer 3, and stored in the storage capacitors 13.

The electric charges stored in the storage capacitors 13 are read therefrom. The gate drive circuit 19 carries out a read operation in the radiographic mode without binning. The gate drive circuit 19 drives the switching elements 15 on a row-by-row basis. That is, the gate drive circuit 19 drives the switching elements 15 by successively applying voltage and sending signals, on the row-by-row basis, to the gate lines D1-D10 connected to the respective rows in the horizontal direction of the switching elements 15. Consequently, the switching elements 15 in the row connected to the gate line G1, for example, are driven, and the charges stored in their respective storage capacitors 13 are read through the data lines D1-D10.

The charges read through the data lines D1-D10 are inputted to the charge-to-voltage converting amplifiers 21, stored in the amplifier's storage capacitors 29, and outputted as amplified voltage signals. The voltage signals converted by the charge-to-voltage converting amplifiers 21 are processed by the multiplexer 23 and analog-to-digital converter 25 in this order, and are outputted from the FPD 1 to be fed as X-ray detection signals into the image processor 31 at the subsequent stage. The image processor 31 carries out other processes required, such as offset correction. In this way, an X-ray image (still image) without binning (1×1 pixel) is acquired. The X-ray image processed by the image processor 31 is displayed on the monitor not shown, or stored in the memory unit not shown.

According to the FPD 1 in Embodiment 1 described above, the drive controller 33 varies the bias voltage Va applied from the bias supply 9 to the conversion layer 3 based on the presence or absence of binning, that is, for the case of carrying out binning where the switching elements 15 are driven on the basis of a plurality of rows at a time by the gate drive circuit 19, and for the case of carrying out no binning where the switching elements 15 are driven on the row-by-row basis by the gate drive circuit 19. Therefore, in the case of the fluoroscopic mode for acquiring images with binning, a lowering of the dynamic range DR can be suppressed. In the case of the radiographic mode with no binning, the spatial resolution MTF can be made high. That is, with a conventional apparatus, dynamic range DR will be reduced when the bias voltage Va required for the radiographic mode is used as it is for the fluoroscopic mode, and spatial resolution MTF will be reduced when the bias voltage Va is set low to suit the fluoroscopic mode. However, this embodiment can secure both high dynamic range DR and high spatial resolution MTF according to the modes of operation.

The drive controller 33 sets the bias voltage Va applied from the bias supply 9 to the conversion layer 3 for the case of carrying out the binning than for the case without the binning. Consequently, the bias voltage Va is set lower for the fluoroscopic mode which acquires images by binning 2×2 pixels, for example, than when no binning is carried out, thereby reducing the amount of read-out charges due to leak current for two pixels, to suppress lowering of dynamic range DR. The bias voltage Va is set higher for the radiographic mode which acquires images with no binning, than when binning is carried out, thereby increasing spatial resolution MTF.

The conversion layer 3 is formed of CdTe or CdZnTe. CdTe or CdZnTe is highly sensitive to incident X-rays, and has a large amount of leak current compared with a-Se, for example. Therefore, when binning 2×2 pixels, the dynamic range DR will lower since the charges due to leak current for two pixels are read. However, by changing the bias voltage Va, the lowering of the dynamic range DR can be suppressed.

### Embodiment 2

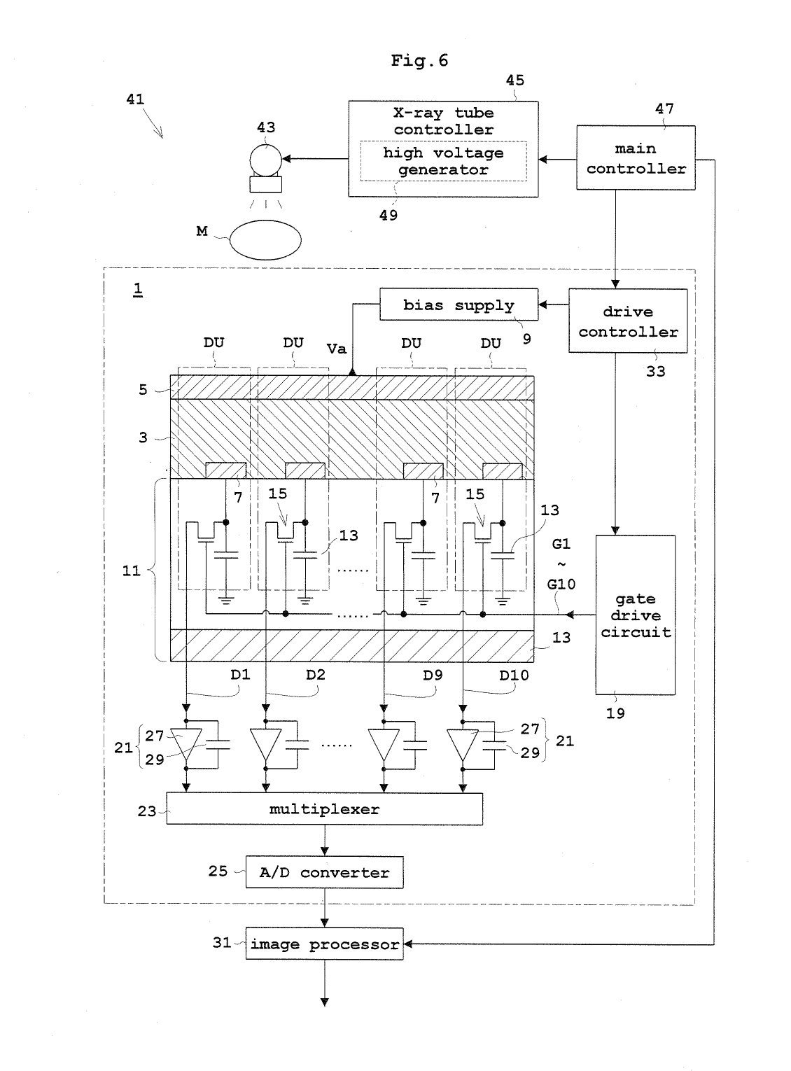

Next, Embodiment 2 of this invention will be described with reference to the drawings. FIG. 6 is a view showing an outline construction of an X-ray apparatus according to Embodiment 2. Components identical to those of the foregoing embodiment will not be described.

Reference is made to FIG. 6. An X-ray apparatus 41 according to Embodiment 2 includes the FPD 1 of Embodiment 1. Further, the X-ray apparatus 41 includes an X-ray tube 43 for emitting X-rays, an X-ray tube controller 45 for controlling the X-ray tube 43 as required for X-ray emission, and a main controller 47 for performing overall control of the various components of the X-ray apparatus 41.

The X-ray tube controller 45 has a high voltage generator 49 for generating tube voltage and tube current for the X-ray tube 3. The main controller 47 operates the X-ray tube controller 45, drive controller 33 of the FPD 1, and image processor 31. The X-ray tube 43 corresponds to the radiation emitter in this invention.

The FPD 1 detects X-rays transmitted through a subject M.

The X-ray apparatus 41 according to Embodiment 2 includes the FPD 1 and the X-ray tube 43 for emitting X-rays. Consequently, in the fluoroscopic mode for acquiring images with binning, the X-ray apparatus 41 can suppress lowering of the dynamic range DR. In the radiographic mode for acquiring images without binning, the spatial resolution MTF can be made high. That is, the X-ray apparatus 41 can secure both high dynamic range DR and high spatial resolution MTF according to readout modes.

In FIG. 6, the FPD 1 includes the bias supply 9, gate drive circuit 19, drive controller 33 and analog-to-digital converter 25. However, the bias supply 9, gate drive circuit 19, drive controller 33 and analog-to-digital converter 25 may be arranged outside the FPD 1. That is, the X-ray apparatus 41 may have, as parts thereof, the bias supply 9, gate drive circuit 19, drive controller 33 and analog-to-digital converter 25. The FPD 1 may have the image processor 31. The main controller 47 may be modified to operate the bias supply 9 and gate drive circuit 19 directly according to the modes of operation, i.e. the radiographic mode and the fluoroscopic mode. In this case, the main controller 47 corresponds to the controller in this invention.

This invention is not limited to the foregoing embodiments, but may be modified as follows:

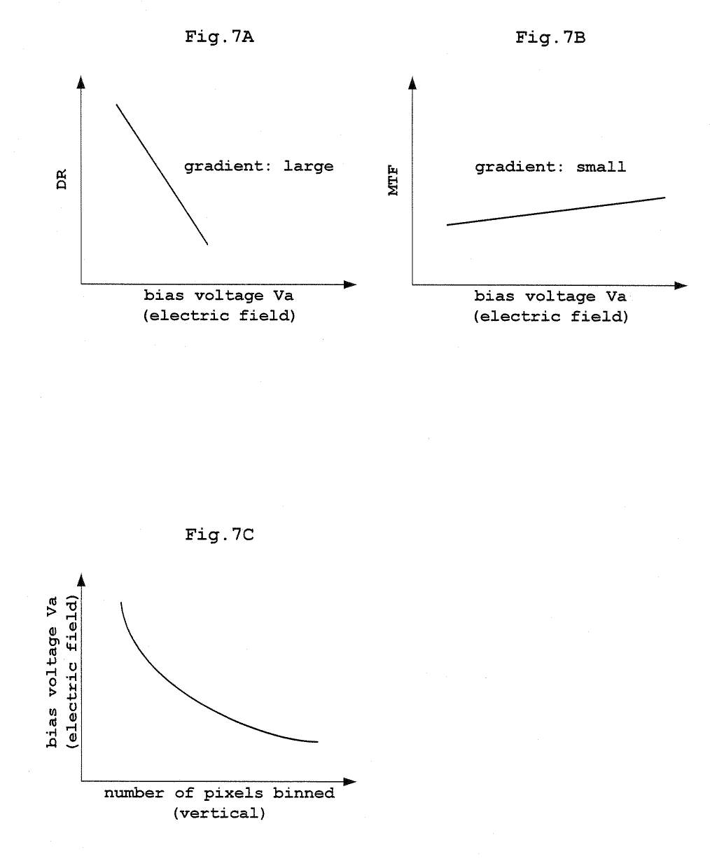

(1) In the foregoing embodiments, dynamic images are acquired by binning 2×2 pixels, but the number of pixels to be binned is not limited to 2×2 pixels. For example, what is binned may be 3×3 pixels, 2×1 pixels vertically and horizontally, or 3×2 pixels vertically and horizontally. That is, any option is applicable as long as the switching elements 15 are driven on the basis of a plurality of rows at a time by the gate drive circuit 19. The number of pixels in the vertical direction to be binned may be in relationships as shown in FIGS. 7A through 7C. FIG. 7A is a view conceptually showing a relationship between bias voltage (electric field) and dynamic range DR based on the number of vertical pixels to be binned according to a modification. FIG. 7B is a view conceptually showing a relationship between bias voltage (electric field) and spatial resolution MTF based on the number of vertical pixels to be binned according to the modification. FIG. 7C is a view conceptually showing a relationship between the number of vertical pixels to be binned and bias voltage (electric field) according to the modification.

An increase in the number of pixels in the vertical direction to be binned, as shown in FIG. 7A, enlarges a gradient indicating variations of the dynamic range DR with the bias voltage Va. As shown in FIG. 7B, a gradient indicating variations of the spatial resolution MTF with the bias voltage Va becomes small. Therefore, as shown in FIG. 7C, the larger is the number of pixels in the vertical direction to be binned, that is the larger is the number of rows of the switching elements 15 driven by the gate drive circuit 19, the lower the bias voltage Va applied from the bias supply 9 to the conversion layer 3 is set. In this way, a lowering of dynamic range DR can be suppressed according to the number of pixels in the vertical direction to be binned (the number of rows).

(2) In the foregoing embodiments, the conversion layer is formed of a-Se, CdTe or CdZnTe which converts incident X-rays directly into electric charges. The invention is not limited to this construction. The conversion layer may be what is called the indirect conversion type having a scintillator layer formed of cesium iodide (CsI), for example, which converts incident X-rays into light, and a photodiode which converts into electric charges the light converted by the scintillator layer. The bias voltage Va is applied to the photodiode in this case.

(3) In the foregoing embodiments, the flat panel X-ray detector (FPD) which detects X-rays is described as an example of the radiation detector. The invention is not limited to this construction. The radiation detector may, for example, be a gamma-ray detector used in an ECT (Emission Computed Tomography) apparatus for detecting gamma rays emitted from a subject medicated with a radioisotope (RI).

This invention may be embodied in other specific forms without departing from the spirit or essential attributes thereof and, accordingly, reference should be made to the appended claims, rather than to the foregoing specification, as indicating the scope of the invention.

What is claimed is:

1. A radiation detector for detecting radiation, comprising:
a conversion layer for converting incident radiation into electric charges;
a bias supply for applying a bias voltage to the conversion layer;
storage capacitors arranged in two dimensions for storing the electric charges converted by the conversion layer;
switching elements arranged in two dimensions for reading the electric charges stored in the storage capacitors;
a gate drive circuit for selectively driving the switching elements on one of a basis of one row at a time and a basis of a plurality of rows at a time; and
a controller for varying the bias voltage applied from the bias supply to the conversion layer according to a case of carrying out binning in which the gate drive circuit drives the switching elements on the basis of the plurality of rows at a time, and a case without the binning in which the gate drive circuit drives the switching elements on the basis of one row at a time.

2. The radiation detector according to claim 1, wherein the controller is arranged to set the bias voltage applied from the bias supply to the conversion layer lower for the case of carrying out the binning than for the case without the binning.

3. The radiation detector according to claim 2, wherein the larger is the number of rows of the switching elements driven by the gate drive circuit, the lower the controller is arranged to set the bias voltage applied from the bias supply to the conversion layer.

4. The radiation detector according to claim 1, wherein the conversion layer is formed of one of CdTe and CdZnTe.

5. The radiation detector according to claim 2, wherein the conversion layer is formed of one of CdTe and CdZnTe.

6. The radiation detector according to claim 3, wherein the conversion layer is formed of one of CdTe and CdZnTe.

7. A radiographic apparatus for acquiring still images and dynamic images, comprising:
a radiation emitter for emitting radiation; and
a radiation detector for detecting radiation transmitted through a subject;
wherein the radiation detector includes:
a conversion layer for converting incident radiation into electric charges;
a bias supply for applying a bias voltage to the conversion layer;
storage capacitors arranged in two dimensions for storing the electric charges converted by the conversion layer;
switching elements arranged in two dimensions for reading the electric charges stored in the storage capacitors;
a gate drive circuit for selectively driving the switching elements on one of a basis of one row at a time and a basis of a plurality of rows at a time; and
a controller for varying the bias voltage applied from the bias supply to the conversion layer according to a case of carrying out binning in which the gate drive circuit drives the switching elements on the basis of the plurality of rows at a time, and a case without the binning in which the gate drive circuit drives the switching elements on the basis of one row at a time.
